(19) United States
(12) Patent Application Publication
(10) Pub. No.: US 2010/0282479 A1
(43) Pub. Date: Nov. 11, 2010

(54) Explosion arresting equipment with disassembleable housing, especially for pipe systems

(76) Inventors: Viadimir Dvoracek, Melnik (CZ); Jan Sedlak, Prana (CZ)

Correspondence Address: Peter R. Ruzek, 24 Green Woods Lane, Farmington, CT, 06085, US

(21) Appl. No.: 12/799,647

(22) Filed: Apr. 29, 2010

(30) Foreign Application Priority Data
May 11, 2009 (CZ) 2009-21189
May 11, 2009 (CZ) 2009-21190
May 11, 2009 (CZ) 2009-21191

(51) Int. Cl. A62C 4/02

(52) U.S. Cl. 169/54; 169/49

(57) ABSTRACT

An explosion arresting assembly, especially for use in pipe systems, includes a housing including a sheath circumferentially surrounding an internal chamber and having two axially spaced end regions, two end elements each juxtaposed with one of the end regions of the sheath and each having a portion extending outwardly of the sheath all around the latter and provided with a plurality of circumferentially distributed holes that are aligned with one another as between the two end elements, at least one of the end elements having an opening communicating with said internal chamber, and a plurality of bolts with associated nuts, the bolts passing through the respective aligned ones of the holes, connecting the two end elements with one another and confining the sheath therebetween. An anti-explosion insert including a stack of substantially planar lamellae and integral or separate distancing elements defining respective passages between such lamellae is tightly received in the internal chamber.

### BACKGROUND OF THE INVENTION

1. Field of the Invention

The present invention relates to explosion arresting equipment with disassembleable housing, especially for pipe systems, which is intended for the prevention and suppression of explosions of highly explosive media in industrial accidents especially in the oil industry, in the chemical industry, in the pharmaceutical industry, but also in the food processing industry.

2. Description of Related Art

Liquid or gaseous media that may form explosive mixtures with air are being used in many industrial fields, including especially the petrochemical, chemical, and pharmaceutical industries, but even the food processing industry. However, the storage of such media, their transportation or processing, and any manipulation with them entails risks of explosion, particularly at critical locations, such as in the airing systems of containers and storage tanks, junctures of pipe systems and at all locations at which it is probable that these media could come into contact with air. Pursuit of minimalization of the consequences of, and avoidance of, such technical accidents is being addressed by the use of anti-explosion barriers, the objective of which is to enable unimpeded passage of gases and vapors or other media, but in the event that an explosion should take place, to prevent the passage of the flame and its transfer from one section to another.

To accomplish this purpose, there has already been developed a multitude of anti-explosion safety devices that are to be placed into pipe systems, the purpose of each if which is to guarantee, in the event of explosion of the explosive medium flowing through it, the suppression of such an explosion to avoid additional damage and to achieve safe operation in industrial plants in which such explosive media are being tranported through pipe systems, stored, or otherwise manipulated.

An example of a known component for anti-explosion safety devices is disclosed in the Czech patent document CZ-PS 295987 that shows an insert of a non-penetrable anti-explosion safety device that is to be inserted into a non-penetrable housing of any technical device or directly into a pipe, and which is constituted by a frame in which there are alternately situated strips and lamellae with wire of circular or polygonal cross-section wound around them, that are wound into the shape of a roll, being confined by the frame and situated transversely in the pipe between respective pipe flanges into the path of passage of the flowing medium.

An important drawback of the anti-explosion safety device using this insert resides, above all, in that a full suppression ability of the insert cannot be assured when the requirements for a highly explosive medium are extreme, in that the individual insert cannot be constructed with such an axial length that it would not be necessary to place a plurality of such inserts into the anti-explosion device between the flanges. Then, however, contact regions come into existence between the individual inserts that constitute undesirable conflagration chambers in which the flame is reignited, so that the resultant suppression of the flame is complicated in this manner. Simultaneously, there is required for the fixation of the inserts in the safety device assembly the installation of support crosses or similar holding partitions which, on the one hand, limit the flow of the medium through the pipe and, in the event of an explosion, again form undesirable chambers or nooks in which the flame is reinitiated and thus the time needed for its suppression is prolonged.

Further known solutions are disclosed, for instance, in the patent documents WO2005014112 and WO2004108219 by Leinemann Christoph, in which similar drawbacks as those discussed above in connection with the patent document CZ-PS 295987 can be observed. These solutions once more utilize anti-explosion inserts of similar constructions that are integrated between pipe flanges, in which dead spaces or chambers in which the flame is reinitiated are formed and thus the time needed for achieving the desired suppression effect is extended. Basically, any obstruction or chamber that is present in the system that is situated in the path of the explosion is the cause, on the one hand, of the retardation of the surge wave of the explosion but, on the other hand, constitutes a location for a possible additional ignition while at the same time causing the extension of the time interval needed for the suppression of the flame.

It has been established that, in order to achieve effective suppression of the flame, it is necessary to provide such a construction of the anti-explosion safety device that it enables, in the highest possible manner, a continuous flow of the medium through the pipe without any significant impediments during the normal operating conditions but which, in the event of an explosion, renders possible a penetration of the surge wave that is as little limited as possible and, on the contrary, its pronounced suppression only in the insert itself, behind which follows, with delay, the flame subdued by the shortage of air. This effect can be achieved, above all, by a selective axial length of the suppressing insert that is constructed as a rigid monolithic unit, the through openings of which are, over their entire lengths, of a constantly identical cross-section, wherein an attempt is made to arrange for the location of the insert in the pipe system or in the safety device housing without resorting to the use of additional auxiliary holding elements in such a manner that as few as possible of dead spaces are created ahead of and behind the insert as considered in the direction of flow of the medium. It has been determined that, for these purposes, it is advantageous to use the lamellar structure of the anti-detonation insert for the construction of the anti-explosion safety device, as disclosed in the Czech utility model CZ 16341 U, in the published patent application CZ-PV 2006-30 and in the utility model CZ 19031 U, the structure of which makes it possible to achieve a selectable axial length that is needed for the suppression of the flame, its easy integration into the housing of the safety device and into the pipe system, and which exhibits structural rigidity and strength while maintaining the requisite parameters not only for the passage of the medium but also for the function of suppression of the penetration of the flame proper.

There has already been proposed a bi-directional anti-explosion safety device, especially for use in pipe systems, utilizing the above discussed principles, as disclosed in the published patent application CZ-PV 2007-313, and which, as was shown in practice, exhibits very good suppressing properties and satisfies the required criteria. However, it has been established that, in some specific cases, its drawback is that the insert in this structure is integrated into a rigid, non-disassemblable housing which, for some end users, complicates the installation into the pipe system; therefore, a need arose to develop a housing that is disassemblable, with the possibility of exchange of lamellar inserts of different axial lengths in accordance with needs, without there being any need of providing a complete new housing for the required axial length of the safety device.

### BRIEF SUMMARY OF THE INVENTION

The present invention relaters to an explosion arresting assembly, especially for use in pipe systems, which comprises a housing including a sheath circumferentially surrounding an internal chamber and having two axially spaced end regions, two end elements each juxtaposed with one of the end regions of the sheath and each having a portion extending outwardly of the sheath all around the latter and provided with a plurality of circumferentially distributed holes that are aligned with one another as between the two end elements, at least one of the end elements having an opening communicating with the internal chamber, and a plurality of bolts with associated nuts, the bolts passing through the respective aligned ones of the holes, connecting the two end elements with one another and confining the sheath therebetween. An anti-explosion insert is tightly received in the internal chamber.

Advantageously, the sheath and the insert have a selectable axial length, so that a variety of assemblies of different axial lengths can be provided for different applications or environments without changing the flow-through profile of the insert.

It is especially advantageous when the internal chamber has a rectangular cross-section and when the insert includes a multitude of substantially planar lamellae stacked in the internal chamber, and intervening distancing elements keeping the lamellae at a predetermined distance from one another and defining respective flame-extinguishing passages therebetween. The distancing elements may be constituted by respective ribs integral with said lamellae or by portions of respective corrugated sheets separate from and interposed between each two of the substantially planar lamellae.

Each of the end elements may be substantially a mirror image of the other, giving the assembly a straight-through configuration, or the other of them may have a portion extending substantially at a right angle with respect to the axis of the sheath, giving said assembly a corner configuration, or the other of the end elements may be constructed to give said assembly an end configuration.

The advantages of the anti-explosion device of the present invention can be found, above all, in that its structure constitutes a very rigid compact unit that demands only a small amount of occupied space, which brings about savings in consumed space in pipe systems and facilitates the manipulation not only during the installation but also during servicing of the device or the pipe system. The construction of the safety device with a disassemblable housing and with axially positionally adjustable flanges or end elements renders possible an easier installation in locations with limited access space, for instance, when the safety device is to be replaced by a different type, without having to change for this purpose the length of the piping to be connected to the device. The construction of the safety device according to the invention makes possible the flow of the medium through the device with only a minimum hindrance, and in the event of an explosion its failure rate is minimal, which, in many instances, makes it possible to reinstall the safety device in the pipe system following the explosion, or to keep the device in the system, or just to replace the insert of the device while keeping the other structural parts of the safety device.

The structure of the safety device also makes it possible to install pressure, temperature or detection sensors at locations at which it is possible to detect the required values and properties of the medium and, by connecting such sensors to an electronic evaluation unit, to monitor the instantaneous state of the flowing medium as well as that of the safety device, and possibly to adjust the sensed values in accordance with the requirements and operational safety. In extreme temperature conditions, it is possible to install a heating element with a controllable sensor of the heating element, thus assuring the heating of the device and thus its capability to operate even at low temperatures, especially when the medium flowing through the safety device has a freezing point within that low temperature range, to avoid the freezing up of the medium and/or the freezing up of the safety device. The provision of the control openings enables an easy visual supervision of the state of the lamellar insert in the course of servicing work.

### BRIEF DESCRIPTION OF THE SEVERAL VIEWS OF THE DRAWING

The present invention is illustrated in the accompanying drawing in which:

FIGS. 1a to 5a show a straight-through configuration of the safety device, in FIG. 1a in an end view, in FIG. 2a in cross-section of one embodiment taken on line A-A of FIG. 1a, in FIG. 3a an alternative embodiment with a smaller axial length also taken on line A-A of FIG. 1a, in FIG. 4a an axonometric view of the body of the safety device with an inlet opening of one end element of the housing, and in FIG. 5a an axonometric view akin to that of FIG. 4a but showing a complete assembly of the safety device, respectively;

FIGS. 1b to 5b show an end configuration of the safety device, in FIG. 1b in an end view, in FIG. 2b in cross-section taken on line B-B of FIG. 1b, in FIG. 3b a top plan view of the safety device illustrating the outer envelope of the device, in FIG. 4b an axonometric view of the body of the safety device with an inlet opening of one end element of the housing, and in FIG. 5b an axonometric view akin to that of FIG. 4b but showing a complete assembly of the safety device, respectively;

FIGS. 1c to 5c show a corner configuration of the safety device, in FIG. 1c in a top plan view, in FIG. 2c in cross-section taken on line C-C of FIG. 1c, in FIG. 3c a side elevational view of the safety device, in FIG. 4c an axonometric view of the body of the safety device with an inlet opening of one end element of the housing, and in FIG. 5c an axonometric view akin to that of FIG. 4c but showing a complete assembly of the safety device, respectively;

FIG. 6 shows an enlarged end view of one embodiment of a lamellar structure of the insert of the safety device as observed through the inlet opening of any one of the safety devices illustrated in the previous drawings;

FIG. 7 shows an enlarged view of the insert of FIG. 6 in an axonometric view;

FIG. 8 shows a cross-sectional view of an individual lamella of the insert of FIG. 7 at an even more enlarged scale;

FIG. 9 shows an axonometric view of a section of the lamella of FIG. 9;

FIG. 10 shows an end view of another embodiment of a lamellar structure of the insert of the safety device; and

FIG. 11 shows in an axonometric view an individual lamella and corrugated element combination for use in the insert of FIG. 10.

### DETAILED DESCRIPTION OF THE PREFERRED EMBODIMENTS

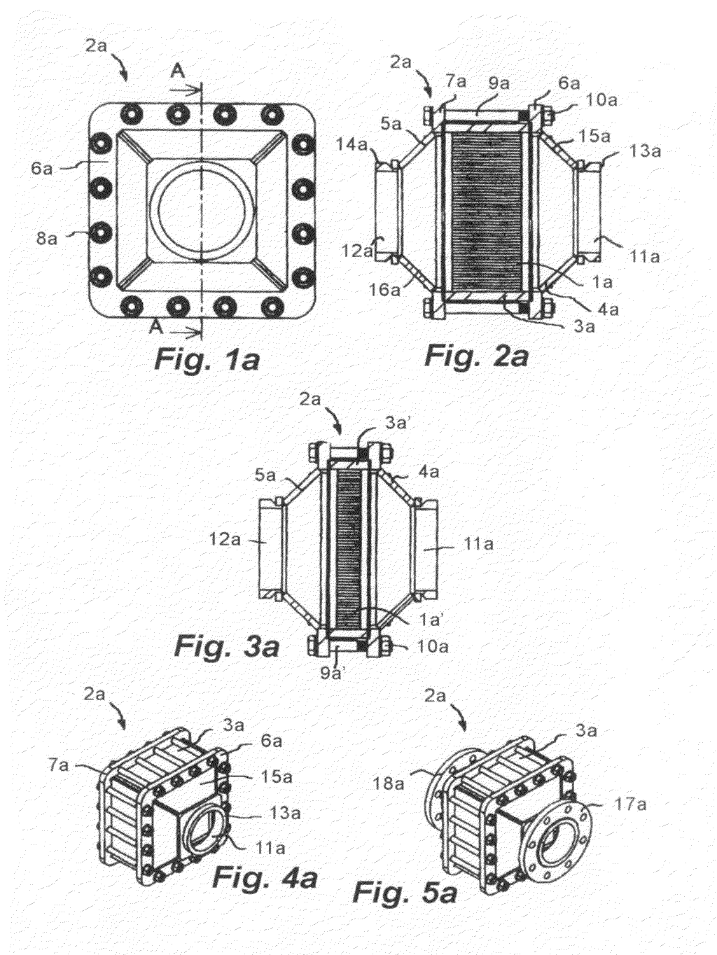

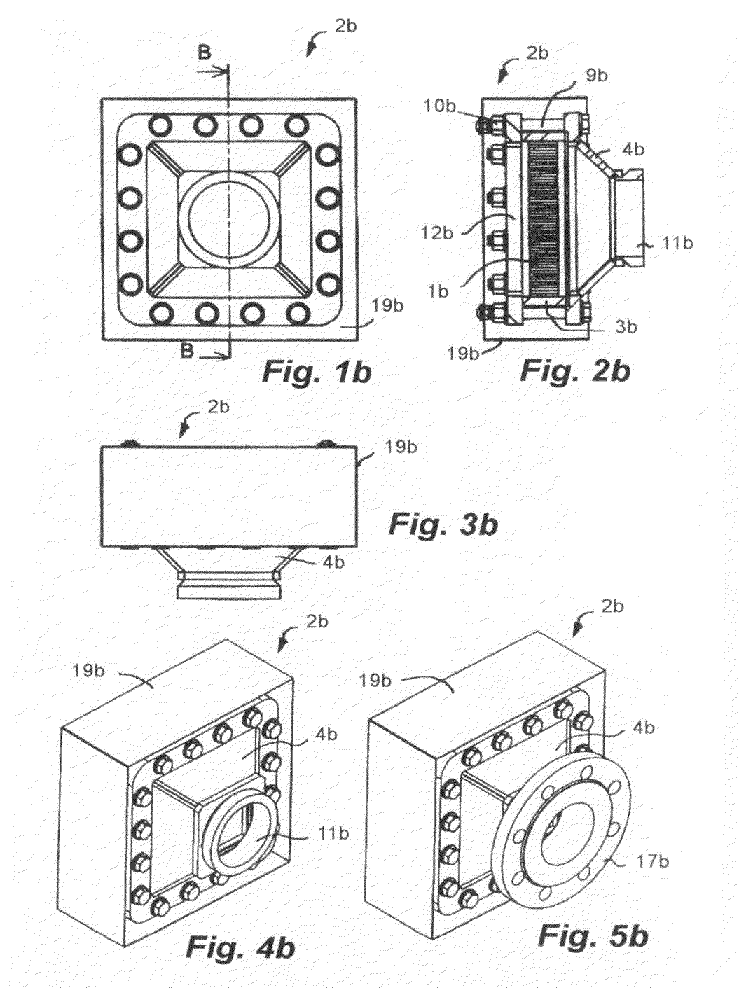

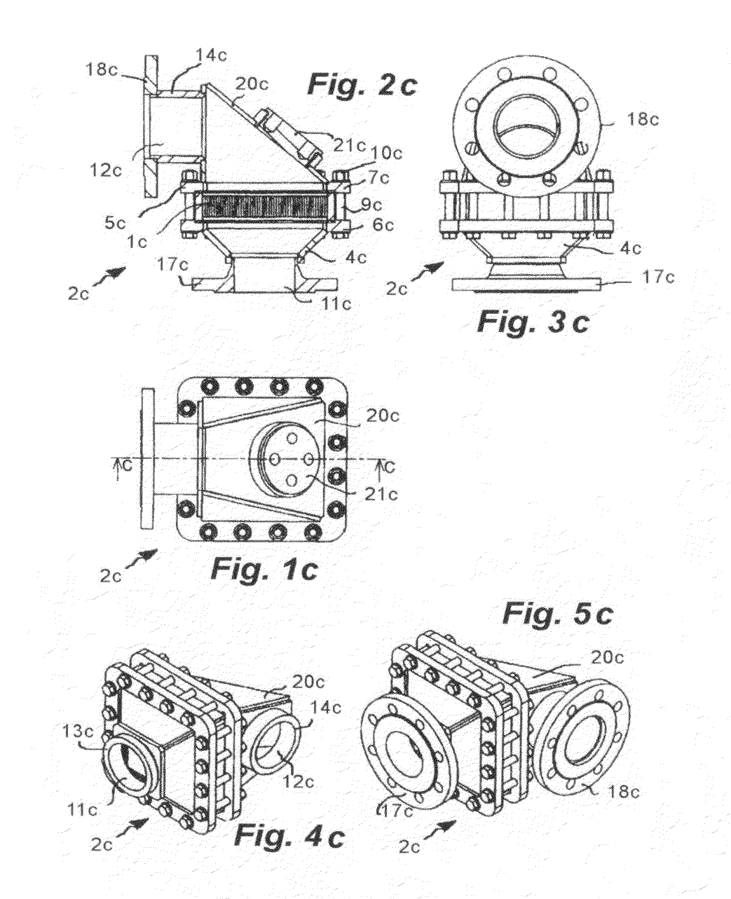

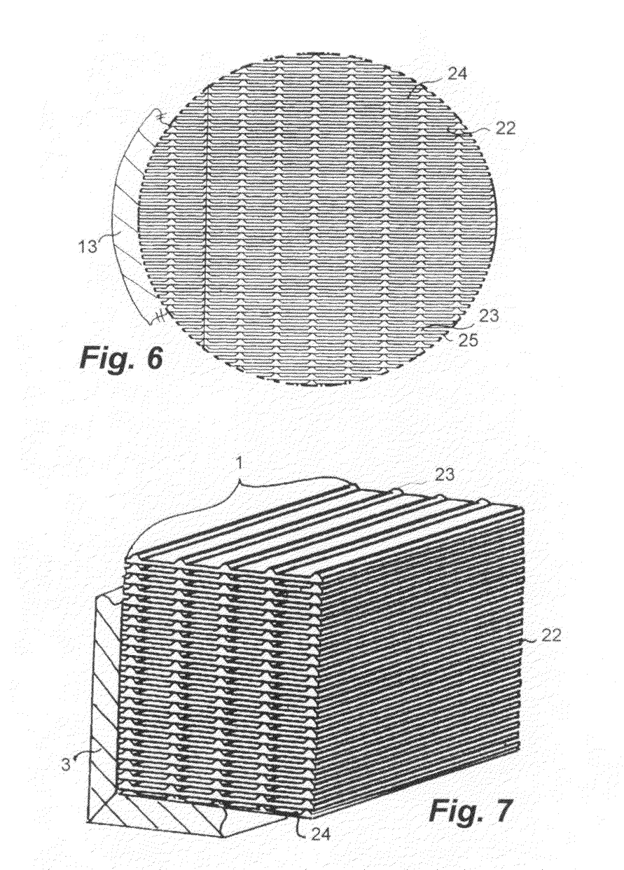

Referring now to the drawing in detail, and first to FIG. 1a thereof, it may be seen that the reference numeral 2a has been used therein to identify a housing of an anti-explosion safety device of the present invention in its entirety. It is to be mentioned at this juncture that in FIGS. 1a to 5c and the text referring thereto, the corresponding parts of the safety device will be identified with corresponding reference numerals but followed by respective letters consistent with the identification of the various Figures, whereas in FIGS. 6 to 11 the corresponding parts will be identified by the same reference numerals but with no letter suffixes attached thereto.

As shown particularly in FIG. 2a, an insert 1a is accommodated, with substantially no leeway, in an internal chamber of a safety device housing 2a. Details of the insert 1a will be discussed later in conjunction with FIGS. 6 to 11; for the time being, it will be sufficient to state that the insert 1a includes a multitude of stacked, as shown superimposed, lamellae. The housing 2a has a generally rectangular, as shown square, cross-sectional configuration (see for instance FIG. 4a) and so, accordingly, does the internal chamber thereof as well as the stack of lamellae accommodated therein.

The internal chamber of the housing 2a is circumferentially bounded by a sleeve or sheath 3a that has two axially spaced end portions. A respective one of two end elements 4a and 5a is situated at each of the end portions of the sheath 3a and has a respective peripheral region 6a and 7a that extends outwardly beyond the sheath 3a and is provided with respective through holes 8a (shown only in FIG. 1a) that are distributed at predetermined intervals over the respective peripheral regions 6a and 7a, the associated ones of them being aligned with one another as between the two peripheral regions 6a and 7a. A corresponding number of bolts 9a passes through such mutually aligned holes 8a and has associated nuts 10a threaded thereonto such that, when the nuts 10a are tightened during the assembly of the safety device, the bolts 9a rigidly and securely connect said end elements 4a and 5a, with the sheath 3a being confined between such connected end elements 4a and 5a.

Each of the end elements 4a and 5a is provided with a respective opening 11a or 12a that is in communication with the internal chamber containing the insert 1a and one of which serves as an inlet for the medium into, and the other as an outlet for the medium from, the internal chamber. It may be seen that the end elements 4a and 5a are basically mirror images of one another so that the safety device can be considered to be bidirectional in that it can be installed in a pipe system in any one of two orientations, with the opening 11a serving as the inlet and the opening 12a as the outlet for the medium in one of these orientations, and vice versa in the other orientation. As shown, the openings 11a and 12a are provided in respective cylindrical regions 13a and 14a of the associated end elements 4a and 5a that are adjoined by respective transitional regions 15a and 16a that transition the substantially circular cross-section of the respective cylindrical region 13a or 14a into the substantially square (or, generally speaking, rectangular) cross-section of the internal chamber containing the insert 1a.

The cylindrical regions 13a and 14a serve for the connection of the safety device with consecutive sections of a pipe system. To this end, they may form an assembly with respective flanges 17a and 18a (see FIG. 5a) that serve for connection with the aforementioned pipe sections.

FIG. 3a of the drawing shows a modified version of the safety device that includes components identical to those shown in FIG. 2a except for those identified by respective primes (i.e. 1a′, 3a′ and 9a′) that differ from those without the primes only in their respective axial lengths.

The flow-through construction of the bi-directional safety device of FIGS. 1a to 5a enables a direct passage of the pressure or surge wave and of the flame through the insert 1a without encountering any obstacles, with the flame being extinguished in the insert 1a merely by utilizing the appropriate axial length of the anti-detonation lamellar insert 1a and its cooling effect on the flame, which is one of the basic parameters for its required function. As a result of the fact that it is possible to install the anti-destination lamellar insert 1a into the housing 2a as a single, monolithic, unit having any desired axial length, otherwise needed individual interruptions and connections, which are mandatory in prior safety device constructions and bring into existence respective air pockets with attendant re-initiation of the flame and lowered suppression effect of the device, are avoided in the construction presented here.

Another embodiment of the safety device of the present invention is shown in FIGS. 1b to 5b. It is similar to that of FIGS. 1a to 5a in so many respects that those components thereof that are of the same construction as those discussed in some detail above (but which, as alluded to above, are provided with letter suffixes b rather than a) need not be, nor will they be, described in detail again. One important difference, however, is that, because this embodiment of the safety device is intended to be used as an end safety device, the end element 5b is not a mirror image of the element 5b; rather, it has, as visible particularly in FIG. 2b of the drawing, a flat, ring-like configuration that bounds the outlet opening 12b for the medium. Moreover, unlike the embodiment of FIGS. 1a to 5a, the embodiment of FIGS. 1b to 5b is shown to include an outer jacket or casing 19b that surrounds the sheath 3b. The advantages of this construction of the end safety device are similar if not identical to those of the bidirectional device discussed above, except that this device is not interposed between two consecutive pipe sections but is located at the end of a pipe or some other conduit.

Turning now to FIGS. 1c to 5c, it may be seen there that once more there are certain components of the safety device that are structurally and functionally equivalent to those discussed above (even though their reference numerals have suffixes c rather than a or b); they will not be discussed here in any detail because such discussion would be repetitive and hence superfluous. Focusing on the differences, it may be observed that this embodiment of the safety device of the present invention is intended for use at location at which the pipe system is to make a turn, as shown, a right-angle turn. For this purpose, the end element 5c is constructed differently from the end element 4c in that it includes a superstructure 20c that carries the cylindrical portion 14c with the inlet or outlet opening 12c not in axial alignment with the cylindrical portion 13c and its opening 11c but rather at a right angle thereto. The superstructure 20c carries a control or supervision lid 21 that permits observation of the interior of the housing 2c and/or introduction of sensors into such interior. Here again, the same advantages as those pointed out before accrue, but this time in a device suited to be amployed at a location at which two pipe sections extending at right angles with respect to one another meet.

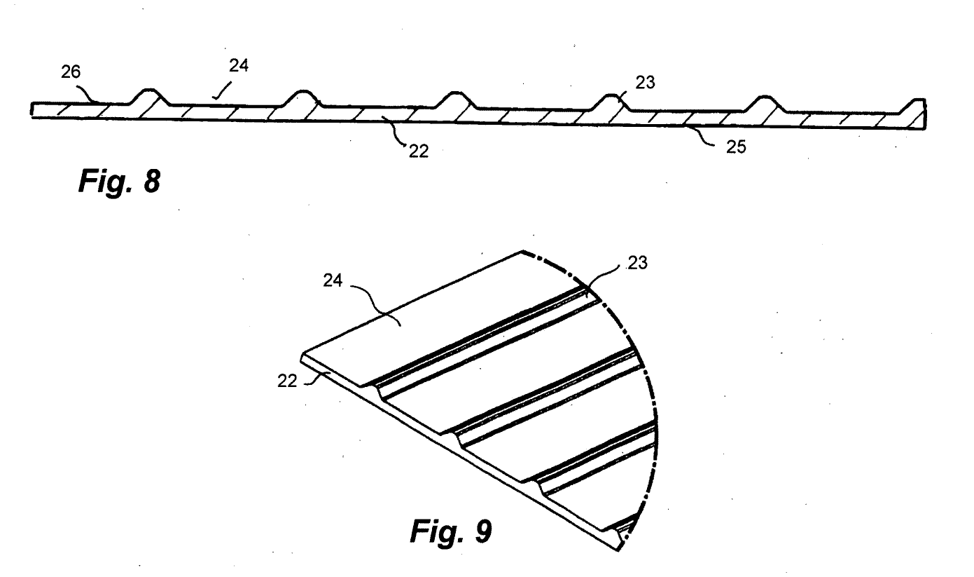

As mentioned before, the insert 1 is of a lamellar construction, including a multitude of lamellae that are stacked in the internal space of the sheath 3. As shown in FIG. 7, all of such lamellae 22 have the same dimensions, so that the stack of them has a parallellepiped configuration. Yet, in the view presented in FIG. 6, which is taken through the opening in the only partially shown cylindrical portion 13 of the end element, only those portions of the lamellar 22 that fit into the outline of that opening are visible. Each of the lamellae 22 has a generally planar configuration, that is it has a surface 25 (the bottom surface shown in FIG. 8) that extends along a plane. Yet the other major surface 26 (the top surface in FIG. 8) of the respective lamella 22 is not planar; rather, it is provided with a plurality of ribs 23. Now, when the insert 1 is assembled, the lamellae 22 are positioned in the stack in the manner shown in FIG. 7, that is, all in the same orientation. This results in a situation in which the planar surface 25 of any lamella 22 except that located at the very bottom of the stack is in contact with the ribs 23 of the lamella 22 situated underneath it; as a result, the surfaces 25 and 26 of these respective two lamellae 22 and the flanks of the ribs 23 together bound respective passages or channels 24 for the flow of the medium therethrough. The lamellae 22 constitute only a minimum impediment to the flow of the medium through the internal space of the housing 2 (taking into account the fact that the cross-section of the internal space greatly exceeds that of the opening of the end element 13 and is only partially diminished by the presence of the lamellae 22 therein) during normal operation. However, should an explosion take place in the section of the pipe or other conduit leading toward the safety device, the resultant flame will be extinguished in the passages 24 due, among others, to the cooling effect of the lamellae 22 on the passing medium, provided, however, that the passages 24 are long enough to accomplish this purpose. The length needed for this depends on the characteristic properties of the medium passing through the insert 1, especially on the temperature of the flame and the speed of the surge wave accompanying or preceding it. An important advantage of the construction in accordance with the present invention is that such length can be easily chosen for the particular medium by appropriately selecting the length of the insert 1, of the sheath 3, and of the bolts 9, without having to change the dimensions or configuration of any other components of the ant-explosion safety device. The lamellae 22 and their ribs 23 can be produced by extrusion, or in a rolling operation.

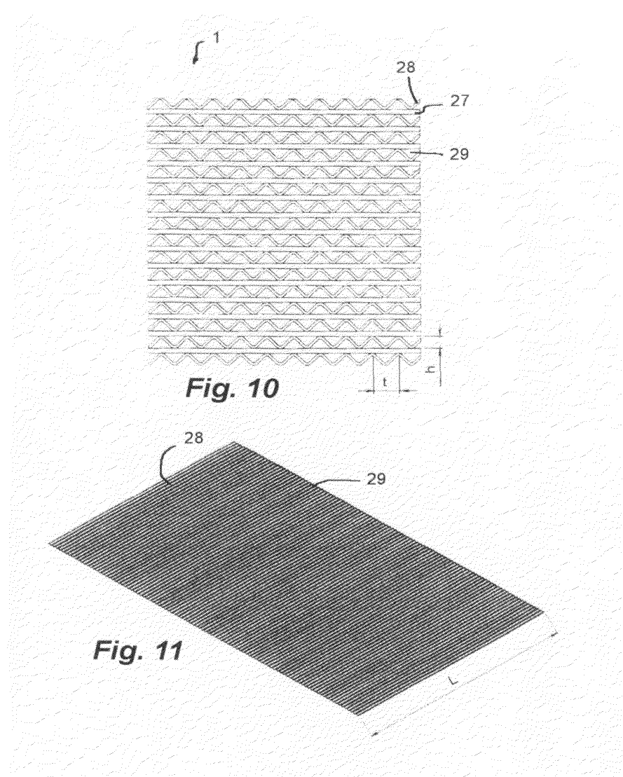

A structure of the insert 1 that does not call for the use of such rather expensive procedures is illustrated in FIGS. 10 and 11 of the drawing. It includes completely planar lamellae 27 that alternate in the stack with corrugated elements 28. In this embodiment, respective passages 29 are formed between the flat lamellae 27 and the corrugations of the associated corrugated elements 28 and have height h and width t. As shown particularly in FIG. 11, the passages 29 extend over the entire axial length L of the respective corrugated element 28 and thus of the insert 1.

Regardless of which construction of the insert 1 described above is chosen for the safety device of the present invention, it has the advantage that, unlike in conventional devices in which the insert is the product of winding with attendant stresses and deformations, the planar configuration of the lamellae 22 or 27 combined with the presence of the ribs 23 or corrugations of the corrugated elements 28 ensures that all of the passages 24 or 29 have the same cross section regardless of their position in the stack, so that they all offer the same resistance to the flow of the medium through them, and the same flame-extinguishing effect in the event that an explosion should occur.

What is claimed as new and for which protection is being sought is revealed in the following claims:

1. An explosion arresting assembly, especially for use in pipe systems, comprising a housing including a sheath circumferentially surrounding an internal chamber and having two axially spaced end regions, two end elements each juxtaposed with one of said end regions of said sheath and each having a portion extending outwardly of said sheath all around the latter and provided with a plurality of circumferentially distributed holes that are aligned with one another as between said two end elements, at least one of said end elements having an opening communicating with said internal chamber, and a plurality of bolts and associated nuts, said bolts passing through the respective aligned ones of said holes, connecting said two end elements with one another and confining said sheath therebetween; and an anti-explosion insert tightly received in said internal chamber.

2. The assembly as defined in claim 1, wherein said sheath and said insert have a selectable axial length.

3. The assembly as defined in claim 1, wherein said internal chamber has a rectangular cross-section; and wherein said insert includes a multitude of substantially planar lamellae stacked in said internal chamber, and intervening distancing elements keeping said lamellae at a predetermined distance from one another and defining respective flame-extinguishing passages therebetween.

4. The assembly as defined in claim 3, wherein said distancing elements are constituted by respective ribs integral with said lamellae.

5. The assembly as defined in claim 3, wherein said distancing elements are constituted by portions of respective corrugated sheets separate from and interposed between each two of said substantially planar lamellae.

6. The assembly as defined in claim 1, wherein each of said end elements is substantially a mirror image of the other, giving said assembly a straight-through configuration.

7. The assembly as defined in claim 1, wherein the other of said end elements has a portion extending substantially at a right angle with respect to the axis of said sheath, giving said assembly a corner configuration.

8. The assembly as defined in claim 1, wherein the other of said end elements is constructed to give said assembly an end configuration.
